(19) United States
(12) Patent Application Publication
(10) Pub. No.: US 2025/0130914 A1
(43) Pub. Date: Apr. 24, 2025

(54) HETEROGENEOUS BIG DATA-COMPATIBLE GATEWAY AND ARTIFICIAL INTELLIGENCE DEEP LEARNING-BASED RISK DETECTION SYSTEM

(71) Applicant: RMA Co., Ltd., Busan (KR)

(72) Inventors: Dong Cheol SEOL, Changwon-si (KR); Woo Gun JEONG, Busan (KR); Kyoung Mi KIM, Busan (KR); Gwang Soo LEE, Gimhae-si, Gyeongsangnam-do (KR)

(21) Appl. No.: 18/536,931

(22) Filed: Dec. 12, 2023

(30) Foreign Application Priority Data
Oct. 19, 2023 (KR) 10-2023-0140399

(51) Int. Cl. G06F 11/32; G06F 11/14; G06F 11/34; G06F 16/28; H04L 9/40

(52) U.S. Cl. CPC G06F 11/327; G06F 11/1402; G06F 11/3409; G06F 16/285; H04L 63/1433

(57) ABSTRACT

A heterogeneous big data-compatible gateway and artificial intelligence (AI) deep learning-based risk detection system includes a heterogeneous big data-compatible gateway configured to collect data from one or more data sources, manage the collected data, and support data-based decision making, and a risk detection system configured to detect risk information. The heterogeneous big data-compatible gateway includes a requirements definition unit configured to define requirements for data; a source connection unit configured to connect to each data source; an authentication unit configured to authenticate the connected data source; a data extraction unit configured to extract data; a data filtering unit configured to remove duplicate data from a plurality of pieces of data and filter out usable data; a data conversion unit configured to convert the data; a data classification unit configured to classify the converted data; and a storage unit configured to store the classified data.

### CROSS-REFERENCE TO RELATED APPLICATION

This application claims priority from Korean Application No. 10-2023-0140399 filed on Oct. 19, 2023, which is incorporated herein by reference in its entirety.

### BACKGROUND

### 1. Technical Field

The present invention relates generally to a heterogeneous big data-compatible gateway and artificial intelligence (AI) deep learning-based risk detection system, and more particularly, to a heterogeneous big data-compatible gateway and AI deep learning-based risk detection system that includes a heterogeneous big data compatible-gateway to efficiently manage and analyze the heterogeneous big data generated by various sensors or various types of equipment in the industrial field and also includes a risk detection system to perform integrated information analysis using AI on the gateway, thereby preventing process problems in advance and improving safety and efficiency at industrial sites.

### 2. Description of the Related Art

The most core element in the field of big data that is leading the information technology (IT) market is real-time data analysis. In particular, as speed becomes more important in corporate decision making, the speed of data analysis to support such decision making is also becoming an important concern. Furthermore, predictive analysis is the final step that a system pursues in corporate risk management.

Recently, as corporate interest in big data analysis has increased, data analysis systems are being introduced in earnest.

However, existing data analysis systems have problems in that they have weaknesses in analyzing a large amount of data and do not reflect the design idea required to analyze data such as social network service (SNS) data and images.

Currently, when the reality of corporate IT investments is taken into consideration, it is almost impossible to completely transform the existing data analysis systems into big data systems. Accordingly, the industry's observation is that the existing systems and technology for the analysis of big data need to coexist for the time being.

Furthermore, a corporate data warehouse stores core information important to a company, and there is a need to separate important information in the case of specific data. Accordingly, it is pointed out that managing all types of data together is not only a waste of storage resources, but is also undesirable in terms of analysis efficiency.

### PRIOR ART LITERATURE

Patent document: Korean Patent No. 10-2354814

### SUMMARY

The present invention has been conceived to overcome the above-described problems, and an object of the present invention is to provide a heterogeneous big data-compatible gateway and AI deep learning-based risk detection system that includes a heterogeneous big data compatible-gateway to manage and analyze the heterogeneous big data efficiently generated by various sensors or various types of equipment in the industrial field and also includes a risk detection system to perform integrated information analysis using AI on the gateway, thereby preventing process problems in advance and improving safety and efficiency at industrial sites.

Another object of the present invention is to provide a heterogeneous big data-compatible gateway and AI deep learning-based risk detection system that efficiently collects and manages data from various data sources via the heterogeneous big data-compatible gateway and then supports data-based decision making and analysis, thereby enabling companies to construct a consistent data environment for business intelligence and data analysis.

Still another object of the present invention is to provide a heterogeneous big data compatible-gateway and AI deep learning-based risk detection system that detects various risk factors using trained AI in advance via the risk detection system and then removes risk occurrence factors in advance.

According to an aspect of the present invention, there is provided a heterogeneous big data-compatible gateway and artificial intelligence (AI) deep learning-based risk detection system, including: a heterogeneous big data-compatible gateway configured to collect data from one or more data sources, manage the collected data, and support data-based decision making; and a risk detection system configured to detect risk information using a trained risk detection model and provide notification of the risk information; wherein the heterogeneous big data-compatible gateway includes: a requirements definition unit configured to define requirements for data according to the amount, type, source, and purpose of data; a source connection unit configured to connect to each data source corresponding to the requirements defined by the requirements definition unit; an authentication unit configured to authenticate the data source connected by the source connection unit and grant a user the right to access the authenticated data source; a data extraction unit configured to extract data from the data source, authenticated by the authentication unit, at preset reference periods; a data filtering unit configured to remove duplicate data from a plurality of pieces of data extracted by the data extraction unit and filter out usable data; a data conversion unit configured to convert the data, filtered out by the data filtering unit, into a preset reference format; a data classification unit configured to classify the data, converted by the data conversion unit, according to the type, source, and scheme of the data; and a storage unit configured to store the data classified by the data classification unit.

The heterogeneous big data-compatible gateway may further include: a security unit configured to manage user rights and control access so that the security of the data stored in the storage unit can be maintained; a monitoring unit configured to monitor the performance of the heterogeneous big data-compatible gateway and perform optimization; a failure detection unit configured to detect a failure of the heterogeneous big data-compatible gateway; a recovery unit configured to recover the heterogeneous big data-compatible gateway when the failure detection unit detects a failure; and an application programming interface (API) provision unit configured to provide an API to access data via the heterogeneous big data-compatible gateway.

The risk detection system may include: a target definition unit configured to define the target of risk; a collection unit configured to collect a plurality of pieces of data according to the target of risk defined by the target definition unit; a pre-processing unit configured to remove abnormal data from the plurality of pieces of data collected by the collection unit, compensate for missing data, and normalize data; a conversion unit configured to convert the data, processed by the preprocessor, into a preset reference format; a dataset generation unit configured to generate a training dataset from the plurality of pieces of data converted by the conversion unit; and a learning unit configured to train a risk detection model using the training dataset generated by the dataset generation unit.

The risk detection system may further include: a sensor unit configured to detect data according to the target of risk defined by the target definition unit; an identification unit configured to identify risk information using the risk detection model trained by the learning unit; a notification unit configured to immediately issue a notification sound when the identification unit identifies risk information; a display unit configured to visually display the risk information identified by the identification unit so that an administrator can easily recognize it; an inspection unit configured to periodically monitor the risk detection model trained by the learning unit; and a performance improvement unit configured to improve the performance of the risk detection model by re-training the risk detection model based on the results of the monitoring performed by the inspection unit. The identification unit may identify the data, detected by the sensor unit, as the risk information when it does not fall within a preset normal range.

The heterogeneous big data-compatible gateway and AI deep learning-based risk detection system according to the present invention includes the heterogeneous big data compatible-gateway to efficiently manage and analyze the heterogeneous big data generated by various sensors or various types of equipment in the industrial field, and also includes the risk detection system to perform integrated information analysis using AI on the gateway. Accordingly, the heterogeneous big data-compatible gateway and AI deep learning-based risk detection system has the effects of preventing process problems in advance and improving safety and efficiency at industrial sites.

Furthermore, the heterogeneous big data-compatible gateway and AI deep learning-based risk detection system according to the present invention efficiently collects and manages data from various data sources via the heterogeneous big data-compatible gateway and then supports data-based decision making and analysis. Accordingly, the heterogeneous big data-compatible gateway and AI deep learning-based risk detection system has the effects of enabling companies to construct a consistent data environment for business intelligence and data analysis.

Moreover, the heterogeneous big data compatible-gateway and AI deep learning-based risk detection system according to the present invention has the effect of detecting various risk factors using trained AI in advance via the risk detection system and then removing risk occurrence factors in advance.

### BRIEF DESCRIPTION OF THE DRAWINGS

The above and other objects, features, and advantages of the present invention will be more clearly understood from the following detailed description taken in conjunction with the accompanying drawings, in which:

FIG. 1 is a conceptual diagram of a heterogeneous big data-compatible gateway and AI deep learning-based risk detection system according to the present invention;

FIG. 2 is a diagram showing the data flow of the heterogeneous big data-compatible gateway and AI deep learning-based risk detection system;

FIG. 3 is a diagram showing the data processing process of a heterogeneous big data-compatible gateway;

FIG. 4 is a diagram showing the security, failure detection, recovery, API provision and cooperative operation processes of the heterogeneous big data-compatible gateway;

FIG. 5 is a diagram showing the data learning process of a risk detection system;

FIG. 6 is a diagram showing the risk detection process of the risk detection system;

FIG. 7 is a diagram showing a data flow when the target of risk is the field of intrusion detection; and

FIG. 8 is a diagram showing a data flow when the target of risk is the field of fire detection.

### DETAILED DESCRIPTION

In order to describe the present invention in detail so that a person having ordinary skill in the art to which the present invention pertains can easily implement the technical spirit of the present invention, embodiments of the present invention will be described with reference to the accompanying drawings below.

However, the following embodiments are merely examples intended to help the understanding of the present invention, and the scope of the present invention is not reduced or limited thereto.

Furthermore, the present invention may be implemented in various different forms, and is not limited to the embodiments described herein.

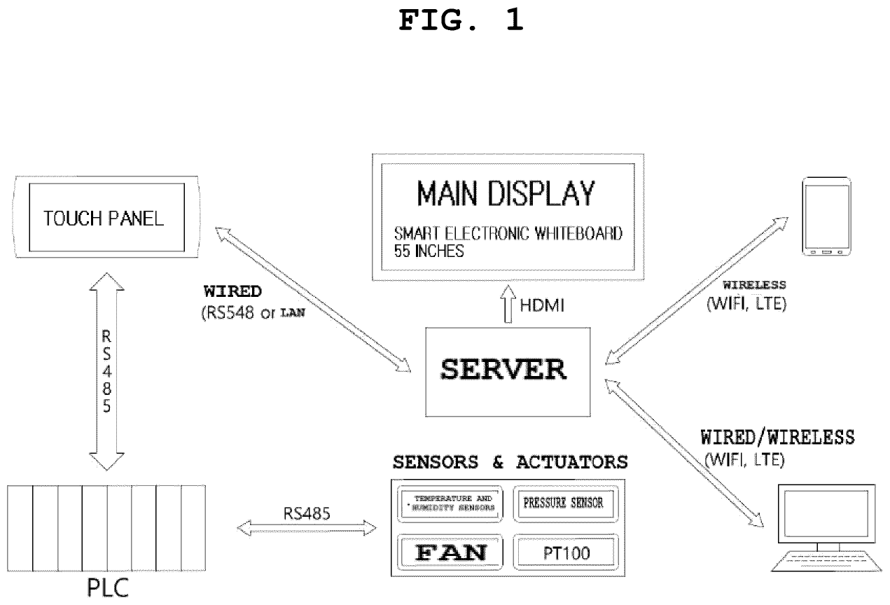

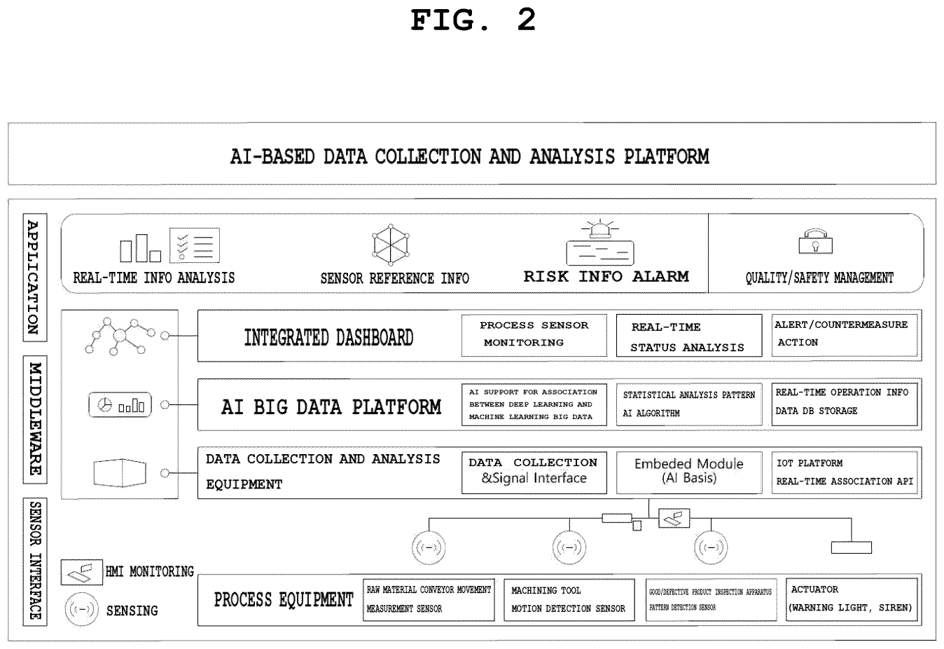

FIG. 1 is a conceptual diagram of a heterogeneous big data-compatible gateway and AI deep learning-based risk detection system 5 according to the present invention, and FIG. 2 is a diagram showing the data flow of the heterogeneous big data-compatible gateway and AI deep learning-based risk detection system 5.

Referring to FIGS. 1 and 2, the heterogeneous big data-compatible gateway and AI deep learning-based risk detection system 5 according to the present invention includes a heterogeneous big data-compatible gateway 10 and a risk detection system 30.

First, the heterogeneous big data-compatible gateway 10 collects data from one or more data sources, manages the collected data, and supports data-based decision making. This not only ensures data compatibility, but also enables tasks, such as analysis, visualization, or machine learning, to be performed.

In addition, the risk detection system 30 detects risk information using a trained risk detection model, and provides notification of the risk information.

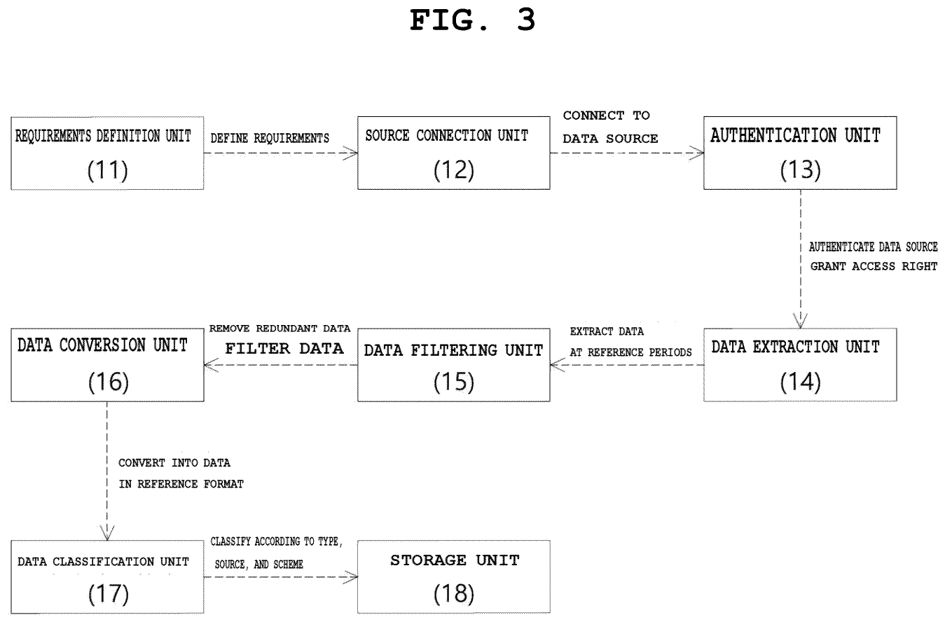

FIG. 3 is a diagram showing the data processing process of the heterogeneous big data-compatible gateway 10.

Referring to FIG. 3, the heterogeneous big data-compatible gateway 10 includes a requirements definition unit 11, a source connection unit 12, an authentication unit 13, a data extraction unit 14, a data conversion unit 16, a data classification unit 17, a storage unit 18, a security unit 19, a monitoring unit 20, a failure detection unit 21, a recovery unit 22, an API provision unit 23, and a cooperative operation unit 24.

First, the requirements definition unit 11 defines requirements for data according to the amount, type, source, and purpose of data.

In addition, the source connection unit 12 connects to a data source corresponding to the requirements defined by the requirements definition unit 11.

In this case, the data source may include a database, a web service, cloud storage, and an external API.

In addition, the authentication unit 13 authenticates the data source connected by the source connection unit 12 and grants a user the right to access the authenticated data source.

In addition, the data extraction unit 14 extracts data from the data source, authenticated by the authentication unit 13, at preset reference periods. This enables the data extraction unit 14 to extract the latest data from the data source.

In addition, the data filtering unit 15 removes duplicate data from a plurality of pieces of data extracted by the data extraction unit 14, and filters out usable data.

In addition, the data conversion unit 16 converts the data, filtered out by the data filtering unit 15, into a preset reference format. This enables the quality of data to be significantly improved.

In addition, the data classification unit 17 classifies the data, converted by the data conversion unit 16, according to the type, source, and scheme of the data. This enables the efficiency of data retrieval and documentation to be improved.

In addition, the data classified by the data classification unit 17 is stored in the storage unit 18. In this case, the storage unit 18 may be implemented in the form of a data warehouse, a data lake, a database, or cloud storage.

This enables data to be backed up and restored, thereby preventing data from being lost in advance.

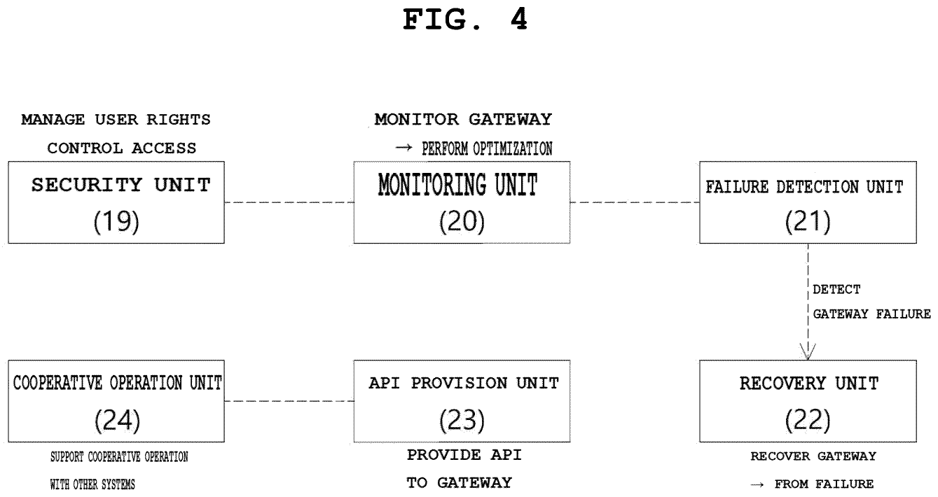

FIG. 4 is a diagram showing the security, failure detection, recovery, API provision and cooperative operation processes of the heterogeneous big data-compatible gateway 10.

Referring to FIG. 4, the security unit 19 manages user rights and controls access so that the security of the data stored in the storage unit 18 can be maintained.

Furthermore, the security unit 19 encrypts the data stored in the storage unit 18 and performs audit logging.

In addition, the monitoring unit 20 monitors the performance of the heterogeneous big data-compatible gateway 10 and performs optimization.

In addition, the failure detection unit 21 detects a failure of the heterogeneous big data-compatible gateway 10.

In addition, the recovery unit 22 recovers the heterogeneous big data-compatible gateway 10 when the failure detection unit 21 detects a failure.

In addition, the API provision unit 23 provides an API to access data via the heterogeneous big data-compatible gateway 10.

In addition, the cooperative operation unit 24 supports cooperative operation with other systems. This enables companies to construct a consistent data environment for business intelligence and data analysis.

In the present invention, it may be possible to successfully implement a gateway that efficiently collects data generated in various formats and protocols and converts it into a reference format. This allows an issue about the compatibility of heterogeneous data to be solved and also allows data to be managed in a centralized manner.

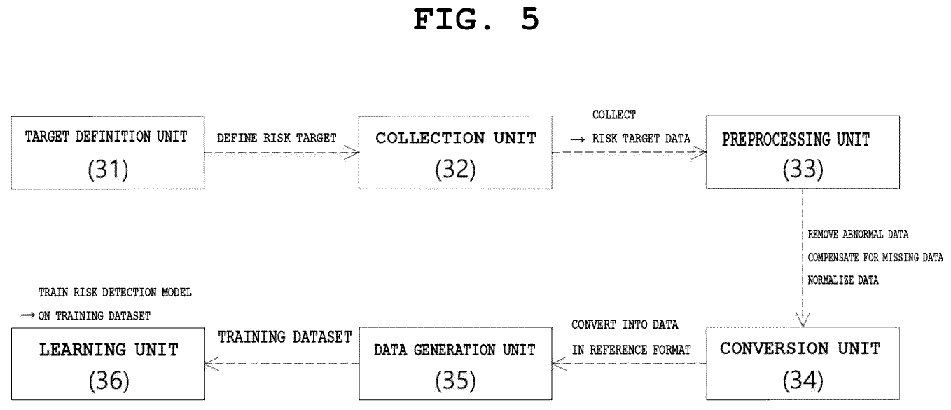

FIG. 5 is a diagram showing the data learning process of the risk detection system 30.

Referring to FIG. 5, the risk detection system 30 includes a target definition unit 31, a collection unit 32, a preprocessing unit 33, a conversion unit 34, a dataset generation unit 35, a learning unit 36, a sensor unit 37, an identification unit 38, a notification unit 39, a display unit 40, an inspection unit 41, and a performance improvement unit 42.

First, the target definition unit 31 defines a target of risk. For example, the target of risk may include the fields of intrusion detection, fire detection, financial fraud detection, environmental monitoring, factory automation, and medical diagnosis.

In addition, the collection unit 32 collects a plurality of pieces of data according to the target of risk defined by the target definition unit 31.

In addition, the pre-processing unit 33 removes abnormal data from the plurality of pieces of data collected by the collection unit 32, compensates for missing data, and normalizes data.

In addition, the conversion unit 34 converts the data, processed by the preprocessor 33, into a preset reference format.

In addition, the dataset generation unit 35 generates a training dataset from the plurality of pieces of data converted by the conversion unit 34.

In addition, the learning unit 36 trains a risk detection model using the training dataset generated by the dataset generation unit 35. More specifically, the learning unit 36 may train the risk detection model using deep learning, machine learning, and statistical analysis technology.

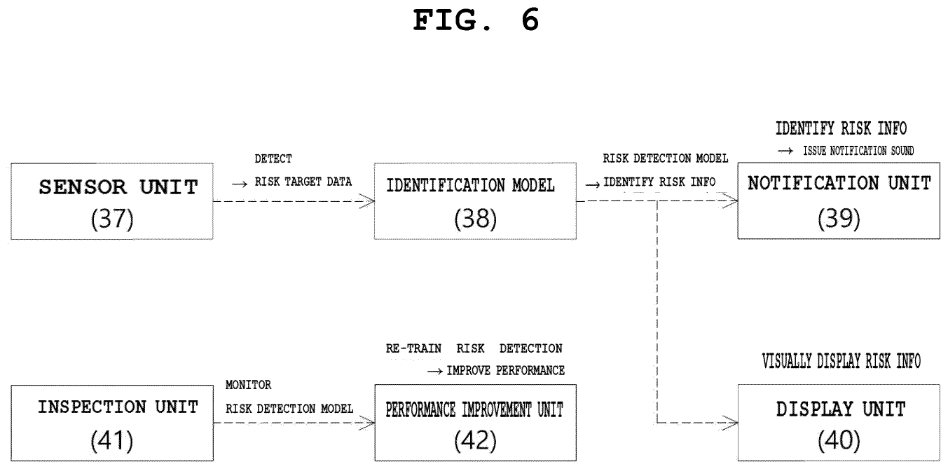

FIG. 6 is a diagram showing the risk detection process of the risk detection system 30.

Referring to FIG. 6, the sensor unit 37 detects data according to the target of risk defined by the target definition unit 31.

In addition, the identification unit 38 identifies risk information using the risk detection model trained by the learning unit 36.

In addition, the notification unit 39 immediately issues a notification sound when the identification unit 38 identifies risk information. This allows risk information to be delivered to an administrator or central server.

In addition, the display unit 40 visually displays the risk information identified by the identification unit 38 so that an administrator can easily recognize it. In this case, the display unit 40 may be implemented in the form of a dashboard or reporting tool.

In addition, the inspection unit 41 periodically monitors the risk detection model trained by the learning unit 36.

In addition, the performance improvement unit 42 improves the performance of the risk detection model by re-training the risk detection model based on the results of the monitoring performed by the inspection unit 41.

Meanwhile, the identification unit 38 identifies the data, detected by the sensor unit 37, as risk information when it does not fall within a preset normal range. In this case, the identification unit 38 identifies risk information in real time so that delay time can be reduced as much as possible.

In addition, the performance improvement unit 42 may improve the performance of the risk detection model by upgrading the risk detection model and strengthening security.

Meanwhile, when the target of risk is the field of fire detection, the sensor unit 37 may include a temperature sensor for detecting temperature inside a building, a smoke sensor for detecting smoke inside a building, and a gas sensor for detecting the concentration of gas inside a building.

In addition, when the target of risk is the field of financial fraud detection, the sensor unit 37 may include a transaction detection unit for detecting an abnormal transaction by analyzing financial transaction data.

In addition, when the target of risk is the field of factory automation, the sensor unit 37 may include IoT devices for detecting a defective product and an error, respectively, during a manufacturing process.

In addition, when the target of risk is the field of environmental monitoring, the sensor unit 37 may include environmental sensors for detecting air, water, and soil pollution, respectively.

In addition, when the target of risk is the field of medical diagnosis, the sensor unit 37 may include a health sensor for detecting a patient's health status.

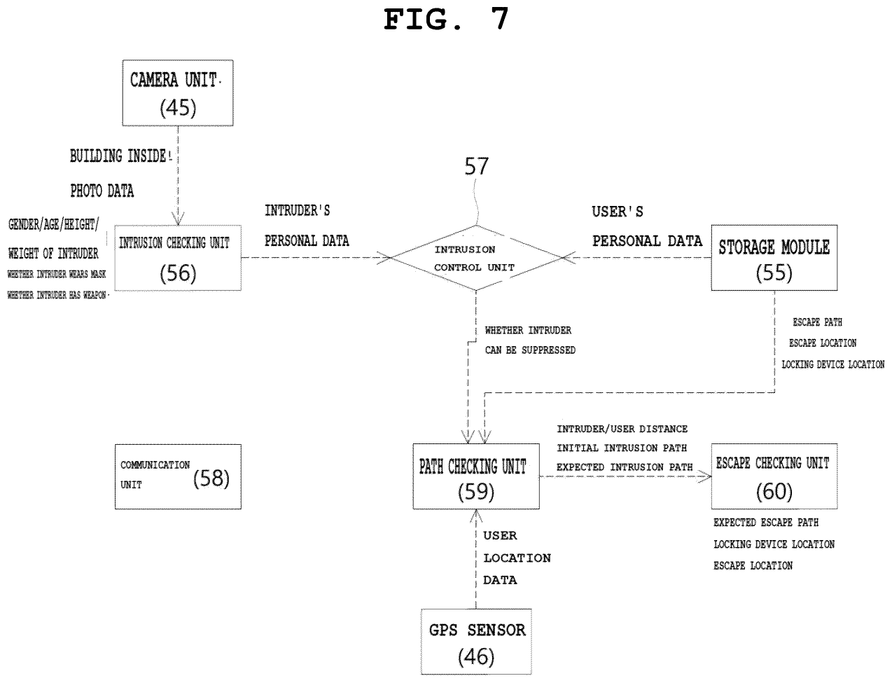

FIG. 7 is a diagram showing a data flow when the target of risk is the field of intrusion detection.

Referring to FIG. 7, when the target of risk is the field of intrusion detection, the sensor unit 37 may further include a camera unit 45 and a GPS sensor 46.

First, the camera unit 45 may include a plurality of camera units provided inside a building and detect an intrusion into the building.

In addition, the GPS sensor 46 is worn on a user and detects the current location of the user.

Meanwhile, the heterogeneous big data-compatible gateway and AI deep learning-based risk detection system 5 according to the present invention may further include a user terminal 50.

First, the user terminal 50 is provided to the user and displays the risk detection data detected by the AI deep learning-based risk detection system 30.

In addition, the AI deep learning-based risk detection system may further include a storage module 55, an intrusion checking unit 56, an intrusion control unit 57, a communication unit 58, a path checking unit 59, and an escape checking unit 60.

First, the storage module 55 stores an escape path inside the building, an escape location, the location of a locking device inside the building, and the user's personal data. In this case, the user's personal data may include the user's gender, age, height, and weight data.

In addition, the intrusion checking unit 56 determines an intruder's personal data, such as the intruder's gender, age, height, weight, whether he or she is wearing a mask, and whether he or she possesses a weapon based on the image data captured by the camera unit 45.

In addition, the intrusion control unit 57 determines whether the intruder can be suppressed by the user by comparing the intruder's personal data identified by the intrusion checking unit 56 with the user's personal data.

In addition, the communication unit 58 transmits data on whether the intruder can be suppressed by the user, determined by the intrusion control unit 57, to the user terminal 50 in the form of text or voice.

In addition, the path checking unit 59 determines the distance between the intruder and the user, the intruder's initial intrusion path, and an expected future intrusion path based on the image data captured by the camera unit 45 and the user's location data detected by the GPS sensor 46.

In addition, the escape checking unit 60 determines the user's expected escape path set such that the intruder and the user do not encounter each other, and the location of a locking device and escape location on the expected escape path set such that the intruder's movement can be blocked based on data on the distance between the intruder and the user, intruder's initial intrusion path, and intruder's future expected intrusion path determined by the path checking unit 59.

In addition, the communication unit 58 transmits data on the user's expected escape path, location of the locking device, and escape location, determined by the escape checking unit 60, to the user terminal 50 in the form of text or voice.

The user may switch the locking device to a locked state while moving along the expected escape path and/or move to the escape location along the expected escape path displayed on the user terminal 50 according to the expected escape path and location of the locking device displayed on the user terminal 50.

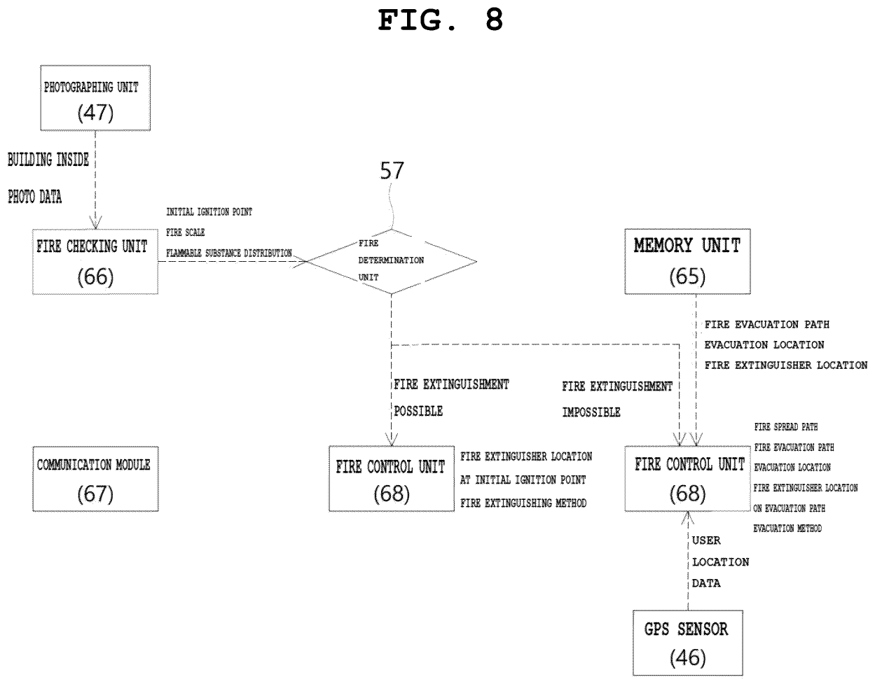

FIG. 8 is a diagram showing a data flow when the target of risk is the field of fire detection.

Referring to FIG. 8, when the task of risk is the field of fire detection, the sensor unit 37 may further include a photographing unit 47.

First, the photographing unit 47 may include a plurality of photographing units provided inside a building and detect whether a fire has occurred inside the building.

In addition, the AI deep learning-based risk detection system may further include a memory unit 65, a fire checking unit 66, a fire determination unit 66, a communication module 67, and a fire control unit 68.

First, the memory unit 65 stores data on a fire evacuation path inside the building, a fire evacuation location, and the location of a fire extinguisher inside the building.

In addition, the fire checking unit 66 determines the initial ignition point of a fire, the scale of the fire, and the distribution of flammable substances around the initial ignition point based on the image data captured by the photographing unit 47. In this case, the scale of the fire may include small, semi-medium, medium, semi-large, and large fires. In this case, the scale of the fire is set to become larger in the sequence of small, semi-medium, medium, semi-large, and large fires.

In addition, the fire checking unit 66 determines whether the fire can be extinguished based on the initial ignition point of the fire, scale of the fire, and distribution of flammable substances around the initial ignition point determined by the fire checking unit 66.

In addition, the communication module 67 transmits data on whether the fire can be extinguished, determined by the fire determination unit 66, to the user terminal 50 in the form of text or voice.

In addition, when the fire checking unit 66 determines that the fire can be extinguished, the fire control unit 68 determines the location of a fire extinguisher closest to the initial ignition point and a fire extinguishing method.

In addition, the communication module 67 transmits data on the location of the fire extinguisher closest to the initial ignition point and the fire extinguishing method, determined by the fire control unit 68, to the user terminal 50 in the form of text or voice.

In addition, when the fire checking unit 66 determines that the fire cannot be extinguished, the fire control unit 68 determines a fire spread path, a fire evacuation path, the location of a fire extinguisher on the evacuation path, and an evacuation method based on the user's location detected by the GPS sensor 46.

In addition, the communication module 67 transmits data on the fire spread path, fire evacuation path, fire evacuation location, location of the fire extinguisher on the fire evacuation path, and evacuation method, determined by the fire control unit 68, to the user terminal 50 in the form of text or voice.

In addition, when a fire spreads along the fire escape path, the user may secure the evacuation path by using the fire extinguisher on the fire escape path based on the fire evacuation path and the location of the fire extinguisher on the fire evacuation path displayed on the user terminal 50.

Furthermore, the user can move to the fire evacuation location along the fire evacuation path based on data on the fire spread path, fire evacuation path, fire evacuation location, and evacuation method displayed on the user terminal 50.

The heterogeneous big data-compatible gateway and AI deep learning-based risk detection system 5 according to the present invention includes the heterogeneous big data compatible-gateway 10 to efficiently manage and analyze the heterogeneous big data generated by various sensors or various types of equipment in the industrial field, and also includes the risk detection system 30 to perform integrated information analysis using AI on the gateway. Accordingly, the heterogeneous big data-compatible gateway and AI deep learning-based risk detection system 5 has the effects of preventing process problems in advance and improving safety and efficiency at industrial sites.

Furthermore, the heterogeneous big data-compatible gateway and AI deep learning-based risk detection system 5 according to the present invention efficiently collects and manages data from various data sources via the heterogeneous big data-compatible gateway 10 and then supports data-based decision making and analysis. Accordingly, the heterogeneous big data-compatible gateway and AI deep learning-based risk detection system 5 has the effects of enabling companies to construct a consistent data environment for business intelligence and data analysis.

Moreover, the heterogeneous big data compatible-gateway and AI deep learning-based risk detection system 5 according to the present invention has the effect of detecting various risk factors using trained AI in advance via the risk detection system 30 and then removing risk occurrence factors in advance.

As described above, the main technical spirit of the present invention is to provide the heterogeneous big data-compatible gateway and AI deep learning-based risk detection system 5. The embodiments described above with reference to the drawings are merely examples, and the true scope of the present invention is based on the patent claims and also encompasses equivalent embodiments that may be present in various forms.

What is claimed is:

1. A heterogeneous big data-compatible gateway and artificial intelligence (AI) deep learning-based risk detection system, comprising:
a heterogeneous big data-compatible gateway configured to collect data from one or more data sources, manage the collected data, and support data-based decision making; and
a risk detection system configured to detect risk information using a trained risk detection model and provide notification of the risk information,
wherein the heterogeneous big data-compatible gateway includes:
a requirements definition unit configured to define requirements for data according to an amount, type, source, and purpose of data;
a source connection unit configured to connect to each data source corresponding to the requirements defined by the requirements definition unit;
an authentication unit configured to authenticate the data source connected by the source connection unit and grant a user a right to access the authenticated data source;
a data extraction unit configured to extract data from the data source, authenticated by the authentication unit, at preset reference periods;
a data filtering unit configured to remove duplicate data from a plurality of pieces of data extracted by the data extraction unit and filter out usable data;
a data conversion unit configured to convert the data, filtered out by the data filtering unit, into a preset reference format;
a data classification unit configured to classify the data, converted by the data conversion unit, according to a type, source, and scheme of the data; and
a storage unit configured to store the data classified by the data classification unit.

2. The heterogeneous big data-compatible gateway and AI deep learning-based risk detection system of claim 1, wherein the heterogeneous big data-compatible gateway further includes:
a security unit configured to manage user rights and control access so that security of the data stored in the storage unit can be maintained;
a monitoring unit configured to monitor performance of the heterogeneous big data-compatible gateway and perform optimization;
a failure detection unit configured to detect a failure of the heterogeneous big data-compatible gateway;
a recovery unit configured to recover the heterogeneous big data-compatible gateway when the failure detection unit detects a failure; and
an application programming interface (API) provision unit configured to provide an API to access data via the heterogeneous big data-compatible gateway.

3. The heterogeneous big data-compatible gateway and AI deep learning-based risk detection system of claim 1, wherein the risk detection system includes:
a target definition unit configured to define a target of risk;
a collection unit configured to collect a plurality of pieces of data according to the target of risk defined by the target definition unit;
a pre-processing unit configured to remove abnormal data from the plurality of pieces of data collected by the collection unit, compensate for missing data, and normalize data;
a conversion unit configured to convert the data, processed by the preprocessor, into a preset reference format;
a dataset generation unit configured to generate training dataset from the plurality of pieces of data converted by the conversion unit; and
a learning unit configured to train a risk detection model using the training dataset generated by the dataset generation unit.

4. The heterogeneous big data-compatible gateway and AI deep learning-based risk detection system of claim 3, wherein the risk detection system further includes:
a sensor unit configured to detect data according to the target of risk defined by the target definition unit;
an identification unit configured to identify risk information using the risk detection model trained by the learning unit;
a notification unit configured to immediately issue a notification sound when the identification unit identifies risk information;
a display unit configured to visually display the risk information identified by the identification unit so that an administrator can easily recognize it;
an inspection unit configured to periodically monitor the risk detection model trained by the learning unit; and
a performance improvement unit configured to improve performance of the risk detection model by re-training the risk detection model based on results of the monitoring performed by the inspection unit,
wherein the identification unit identifies the data, detected by the sensor unit, as the risk information when it does not fall within a preset normal range.
